(19) United States
(12) Patent Application Publication
(10) Pub. No.: US 2010/0085436 A1
(43) Pub. Date: Apr. 8, 2010

(54) HAND MOVEMENT CORRECTION APPARATUS, IMAGE PICKUP APPARATUS, HAND MOVEMENT CORRECTION PROGRAM, IMAGE PICKUP PROGRAM, HAND MOVEMENT CORRECTION METHOD

(75) Inventor: Toshiyuki Ohno, Tokyo (JP)

Correspondence Address: TUROCY & WATSON, LLP, 127 Public Square, 57th Floor, Key Tower, CLEVELAND, OH, 44114, US

(73) Assignees: KABUSHIKI KAISHA TOSHIBA, Minato-ku, Tokyo (JP); TOSHIBA SOLUTIONS CORPORATION, Minato-ku, Tokyo (JP)

(21) Appl. No.: 12/532,214

(22) PCT Filed: Feb. 18, 2008
(86) PCT No.: PCT/JP2008/052617

§ 371 Date: Sep. 21, 2009

(30) Foreign Application Priority Data
Mar. 23, 2007 (JP) 2007-075746

(51) Int. Cl. H04N 5/228

(52) U.S. Cl. 348/208.1; 348/E05.031

(57) ABSTRACT

Provided is a hand movement correction apparatus that performs hand movement correction for an image pickup apparatus. The device acquires a variation signal representing the movement of the image pickup apparatus and acquires a first signal obtained by extracting a signal of a frequency not less than a predetermined frequency from the acquired variation signal. The device further acquires a second signal obtained by extracting a signal of a frequency not more than the predetermined frequency from the acquired variation signal and adding the extracted signal to the first signal. The device then switches signal output from the first signal to second signal at the timing at which the start of the exposure processing in the image pickup apparatus is determined and calculates a hand movement correction amount based on the output signal.

### TECHNICAL FIELD

The present invention relates to a hand movement correction apparatus for correcting a hand movement which may occur when an image pickup apparatus is used to perform image pickup, a hand movement correction program, a hand movement correction method, an image pickup apparatus having a hand movement correction function, an image pickup program, and an image pickup method.

### BACKGROUND ART

As a hand movement correction method for correcting a hand movement which may occur when an image pickup apparatus is used to perform image pickup, a method (shift lens method) using a shift lens, which is a kind of optical hand movement correction method, is known. The shift lens method is a hand movement correction method utilizing refraction of light, in which an angular speed sensor or the like is used to detect movement of an image pickup apparatus. The shift lens is driven in such a direction as to counteract the movement (positional shift of light that has reached the image pickup device) detected by the angular speed sensor during the time from the moment of the start of exposure to the end of exposure to correct the optical axis so as to allow the light to reach a proper point.

The correction range in the shift lens method is restricted by the drive range and the like of the shift lens and, therefore, the correction needs to be performed within the drive range. In the case where the shift lens is positioned near the center of a lens system, the shift lens can be driven over a wide range, so that the correction range is widened. However, as the shift lens is apart from the center thereof, the correction range becomes narrowed. Thus, at the moment of the start of exposure, the success rate of hand movement correction image pickup operation is higher in the case where the shift lens is positioned near the center of the lens system than in the case where the shift lens is apart from the center thereof.

As a method for keeping the shift lens near the center of the lens system, there is available a method that applies high-pass filtering to a variation signal obtained based on the movement detected by the angular speed sensor to remove a low-frequency component from the variation signal. In this method, however, an ultra-low-frequency component caused by unintentional movement of a user of an image pickup apparatus is also removed, which significantly reduces the low-frequency side hand movement correction amount.

As a prior art relating to the present invention, there is available a hand movement correction method that reduces the hand movement correction amount when detecting a hand movement correction amount exceeding a predetermined correction amount and, after that, increases the hand movement correction amount when the correction amount becomes a certain level (i.e., when the shift lens is positioned near the center of the lens system). In this method, however, a break in the continuity of the hand movement correction amount occurs, which may reduce the image pickup success rate.

Further, there is known a method that changes the coefficient or constant of a digital filter at the timing of the start of exposure to thereby change optical performance characteristics (e.g., Patent Document 1). Further, there is a known a method in which an image pickup apparatus constantly performs correction calculation and controls ON/OFF of control output along with the start of exposure (e.g., Patent Document 2).

### Patent Document 1: Japanese Laid-Open Patent Publication No. 2005-99831

### Patent Document 2: Japanese Laid-Open Patent Publication No. 05-207356

### DISCLOSURE OF THE INVENTION

### Problems to be Solved by the Invention

The time constant is defined for the digital filter. As the time constant, a value thereof used in the last and the last but one image pickup operation is also used for calculation in the current image pickup operation in some case, depending on the order of the filter, so that it is difficult to instantly obtain an effective value even if the time constant is changed as in the Patent Document 1. Further, a configuration as disclosed in Patent Document 2 in which output is controlled along with the start of exposure is not enough to ensure that the control of the shift lens is always started at the center of the lens system, with the result that the correction range cannot effectively be utilized.

The present invention has been made in view of the above problems, and an object thereof is to significantly improve the image pickup success rate (hand movement correction effect) by ensuring effective utilization of the correction range and by instantly changing characteristics at the moment of the start of exposure while keeping continuity of the hand movement correction amount during exposure.

### Means for Solving the Problems

To solve the above problem, according to a first aspect of the present invention, there is provided a hand movement correction apparatus that performs hand movement correction for an image pickup apparatus, including: a variation signal acquisition section that acquires a variation signal representing the movement of the image pickup apparatus; a first signal acquisition section that acquires a first signal obtained by extracting a signal of a frequency not less than a predetermined frequency from the variation signal acquired by the variation signal acquisition section; a second signal acquisition section that acquires a second signal obtained by extracting a signal of a frequency not more than a predetermined frequency from the variation signal acquired by the variation signal acquisition section and adding the extracted signal to the first signal; an exposure start determination section that determines the start of exposure processing performed in the image pickup apparatus; a signal switch section that switches signal output from the first signal acquired by the first signal acquisition section to second signal acquired by the second signal acquisition section at the timing at which the start of the exposure processing is determined by the exposure start determination section; and a correction amount calculation section that calculates a hand movement correction amount based on the signal output from the signal switch section.

In the above hand movement correction apparatus according to the present invention, the correction amount calculation section calculates, at the determination timing, the hand movement correction amount based on the second signal using the hand movement correction amount that has been calculated based on the first signal as an initial value.

In the above hand movement correction apparatus according to the present invention, the correction amount calculation section calculates, at the timing, the hand movement correction amount based on the second signal with the hand movement correction amount that has been calculated based on the first signal reset.

The above hand movement correction apparatus according to the present invention includes a drive section that drives an optical system based on the hand movement correction amount calculated by the correction amount calculation section.

The above hand movement correction apparatus according to the present invention includes a drive section that drives an image pickup device based on the hand movement correction amount calculated by the correction amount calculation section.

Further, to solve the above problem, according to a second aspect of the present invention, there is provided a hand movement correction apparatus that performs hand movement correction for an image pickup apparatus, including: an angular speed detection section that detects an angular speed representing the movement of the image pickup apparatus; a high-pass filter section that outputs a DC-cut data obtained by removing a DC component from the angular speed detected by the angular speed detection section; an integration processing section that outputs, as position data, the position of the image pickup apparatus based on the DC-cut data output from the high-pass filter section; a low-pass filter section that extracts, for output, low-frequency component data of a frequency not more than a frequency developed based on a variation caused due to hand movement caused at the time of image pickup from the position data output from the integration processing section; a motion vector calculation section that applies inversion calculation to the motion vector of an object to be image-picked up which is picked up by the image pickup apparatus using sign inversion to output motion vector calculation data; a mode controller that determines the state of exposure processing performed in the image pickup apparatus and manages image pickup operation mode information which is information concerning an image pickup method; a position data storage section that stores, at the timing of the start of the exposure processing determined by the mode controller, the position data output from the integration processing section as stored position data; a low-frequency component storage section that stores, at the timing of the start of the exposure processing determined by the mode controller, the low-frequency component data output from the low-pass filter section as stored low-frequency data; a selector section that selects, as an offset value, one of the position data, low-frequency component data, stored position data, stored low-frequency data, and motion vector calculation data based on the image pickup operation mode information managed by the mode controller and the state of the exposure processing determined by the mode controller; and an offset controller that performs calculation for the position data output from the integration processing section using the offset value selected by the selector section to output the correction amount of the hand movement correction.

Further, to solve the above problem, according to a third aspect of the present invention, there is provided an image pickup apparatus that can perform hand movement correction, including: an image pickup device; an optical system that guides light to the image pickup device; a variation signal acquisition section that acquires a variation signal representing the movement of the image pickup apparatus; a first signal acquisition section that acquires a first signal obtained by extracting a signal of a frequency not more than a first frequency from the variation signal acquired by the variation signal acquisition section; a second signal acquisition section that acquires a second signal obtained by extracting a signal of a frequency not more than a second frequency less than the first frequency from the variation signal acquired by the variation signal acquisition section; an exposure start determination section that determines the start of exposure processing performed in the image pickup apparatus; a signal switch section that switches signal output from the first signal acquired by the first signal acquisition section to second signal acquired by the second signal acquisition section at the timing at which the start of the exposure processing is determined by the exposure start determination section; a correction amount calculation section that calculates a hand movement correction amount based on the signal output from the signal switch section; and a drive section that drives at least one of the optical system and image pickup device based on the hand movement correction amount calculated by the correction amount calculation section.

Further, to solve the above problem, according to a fourth aspect of the present invention, there is provided a hand movement correction program allowing a computer to execute hand movement correction for an image pickup apparatus; the program allowing the computer to execute: a variation signal acquisition step that acquires a variation signal representing the movement of the image pickup apparatus; a first signal acquisition step that acquires a first signal obtained by extracting a signal of a frequency not less than a predetermined frequency from the variation signal acquired by the variation signal acquisition step; a second signal acquisition step that acquires a second signal obtained by extracting a signal of a frequency not more than a predetermined frequency from the variation signal acquired by the variation signal acquisition step and adding the extracted signal to the first signal; an exposure start determination step that determines the start of exposure processing performed in the image pickup apparatus; a signal switch step that switches signal output from the first signal acquired by the first signal acquisition step to second signal acquired by the second signal acquisition step at the timing at which the start of the exposure processing is determined by the exposure start determination step; and a correction amount calculation step that calculates a hand movement correction amount based on the signal output from the signal switch step.

In the above hand movement correction program according to the present invention, the correction amount calculation step calculates, at the timing, the hand movement correction amount based on the second signal using the hand movement correction amount that has been calculated based on the first signal as an initial value.

In the above hand movement correction program according to the present invention, the correction amount calculation step calculates, at the timing, the hand movement correction amount based on the second signal with the hand movement correction amount that has been calculated based on the first signal reset.

The above hand movement correction program according to the present invention allows the computer to execute a drive step that drives an optical system based on the hand movement correction amount calculated by the correction amount calculation step.

The above hand movement correction program according to the present invention allows the computer to execute a drive step that drives an image pickup device based on the hand movement correction amount calculated by the correction amount calculation step.

Further, to solve the above problem, according to a fifth aspect of the present invention, there is provided a hand movement correction program allowing a computer to execute hand movement correction for an image pickup apparatus; the program allowing the computer to execute: an angular speed acquisition step that acquires a rotation angular speed data representing the movement of the image pickup apparatus; a high-pass filter step that outputs a DC-cut data obtained by removing a DC component from the angular speed data acquired by the angular speed acquisition step; an integration processing step that outputs, as position data, the position of the image pickup apparatus based on the DC-cut data output from the high-pass filter step; a low-pass filter step that extracts, for output, low-frequency component data of a frequency not more than a frequency developed based on a variation caused due to hand movement caused at the time of image pickup from the position data output from the integration processing step; a motion vector calculation step that applies inversion calculation to the motion vector of an object to be image-picked up which is picked up by the image pickup apparatus using sign inversion to output motion vector calculation data; a mode control step that determines the state of exposure processing performed in the image pickup apparatus and manages image pickup operation mode information which is information concerning an image pickup method; a position data storage step that stores, at the timing of the start of the exposure processing determined by the mode control step, the position data output from the integration processing step as stored position data; a low-frequency component storage step that stores, at the timing of the start of the exposure processing determined by the mode control step, the low-frequency component data output from the low-pass filter step as stored low-frequency data; a selector step that selects, as an offset value, one of the position data, low-frequency component data, stored position data, stored low-frequency data, and motion vector calculation data based on the image pickup operation mode information managed by the mode control step and the state of the exposure processing determined by the mode control step; and an offset control step that performs calculation for the position data output from the integration processing step using the offset value selected by the selector step to output the correction amount of the hand movement correction.

Further, to solve the above problem, according to a sixth aspect of the present invention, there is provided an image pickup program of an image pickup apparatus that includes an image pickup device and an optical system that guides light to the image pickup device and that can perform hand movement correction, the program allowing a computer to execute: a variation signal acquisition step that acquires a variation signal representing the movement of the image pickup apparatus; a first signal acquisition step that acquires a first signal obtained by extracting a signal of a frequency not more than a first frequency from the variation signal acquired by the variation signal acquisition step; a second signal acquisition step that acquires a second signal obtained by extracting a signal of a frequency not more than a second frequency less than the first frequency from the variation signal acquired by the variation signal acquisition step; an exposure start determination step that determines the start of exposure processing performed in the image pickup apparatus; a signal switch step that switches signal output from the first signal acquired by the first signal acquisition step to second signal acquired by the second signal acquisition step at the timing at which the start of the exposure processing is determined by the exposure start determination step; a correction amount calculation step that calculates a hand movement correction amount based on the signal output from the signal switch step; and a drive step that drives at least one of the optical system and image pickup device based on the hand movement correction amount calculated by the correction amount calculation step.

Further, to solve the above problem, according to a seventh aspect of the present invention, there is provided a hand movement correction method that performs hand movement correction for an image pickup apparatus, including: a variation signal acquisition step that acquires a variation signal representing the movement of the image pickup apparatus; a first signal acquisition step that acquires a first signal obtained by extracting a signal of a frequency not less than a predetermined frequency from the variation signal acquired by the variation signal acquisition step; a second signal acquisition step that acquires a second signal obtained by extracting a signal of a frequency not more than a predetermined frequency from the variation signal acquired by the variation signal acquisition step and adding the extracted signal to the first signal; an exposure start determination step that determines the start of exposure processing performed in the image pickup apparatus; a signal switch step that switches signal output from the first signal acquired by the first signal acquisition step to second signal acquired by the second signal acquisition step at the timing at which the start of the exposure processing is determined by the exposure start determination step; and a correction amount calculation step that calculates a hand movement correction amount based on the signal output from the signal switch step.

In the above hand movement correction method according to the present invention, the correction amount calculation step calculates, at the timing, the hand movement correction amount based on the second signal using the hand movement correction amount that has been calculated based on the first signal as an initial value.

In the above hand movement correction program according to the present invention, the correction amount calculation step calculates, at the timing, the hand movement correction amount based on the second signal with the hand movement correction amount that has been calculated based on the first signal reset.

The above hand movement correction method according to the present invention includes a drive step that drives an optical system based on the hand movement correction amount calculated by the correction amount calculation step.

The above hand movement correction apparatus according to the present invention includes a drive step that drives an image pickup device based on the hand movement correction amount calculated by the correction amount calculation step.

Further, to solve the above problem, according to an eighth aspect of the present invention, there is provided a hand movement correction method that performs hand movement correction for an image pickup apparatus, including: an angular speed acquisition step that acquires a rotation angular speed data representing the movement of the image pickup apparatus; a high-pass filter step that outputs a DC-cut data obtained by removing a DC component from the angular speed data acquired by the angular speed acquisition step; an integration processing step that outputs, as position data, the position of the image pickup apparatus based on the DC-cut data output from the high-pass filter step; a low-pass filter step that extracts, for output, low-frequency component data of a frequency not more than a frequency developed based on a variation caused due to hand movement caused at the time of image pickup from the position data output from the integration processing step; a motion vector calculation step that applies inversion calculation to the motion vector of an object to be image-picked up which is picked up by the image pickup apparatus using sign inversion to output motion vector calculation data; a mode control step that determines the state of exposure processing performed in the image pickup apparatus and manages image pickup operation mode information which is information concerning an image pickup method; a position data storage step that stores, at the timing of the start of the exposure processing determined by the mode control step, the position data output from the integration processing step as stored position data; a low-frequency component storage step that stores, at the timing of the start of the exposure processing determined by the mode control step, the low-frequency component data output from the low-pass filter step as stored low-frequency data; a selector step that selects, as an offset value, one of the position data, low-frequency component data, stored position data, stored low-frequency data, and motion vector calculation data based on the image pickup operation mode information managed by the mode control step and the state of the exposure processing determined by the mode control step; and an offset control step that performs calculation for the position data output from the integration processing step using the offset value selected by the selector step to output the correction amount of the hand movement correction.

Further, to solve the above problem, according to a ninth aspect of the present invention, there is provided an image pickup method of an image pickup apparatus that includes an image pickup device and an optical system that guides light to the image pickup device and that can perform hand movement correction, the method including: a variation signal acquisition step that acquires a variation signal representing the movement of the image pickup apparatus; a first signal acquisition step that acquires a first signal obtained by extracting a signal of a frequency not more than a first frequency from the variation signal acquired by the variation signal acquisition step; a second signal acquisition step that acquires a second signal obtained by extracting a signal of a frequency not more than a second frequency less than the first frequency from the variation signal acquired by the variation signal acquisition step; an exposure start determination step that determines the start of exposure processing performed in the image pickup apparatus; a signal switch step that switches signal output from the first signal acquired by the first signal acquisition step to second signal acquired by the second signal acquisition step at the timing at which the start of the exposure processing is determined by the exposure start determination step; a correction amount calculation step that calculates a hand movement correction amount based on the signal output from the signal switch step; and a drive step that drives at least one of the optical system and image pickup device based on the hand movement correction amount calculated by the correction amount calculation step.

### BRIEF DESCRIPTION OF THE DRAWINGS

FIG. 1 is a functional block diagram illustrating a hand movement correction controller 1 in the first embodiment of the present invention;

FIG. 2 is a view illustrating a configuration of a hand movement correction apparatus in the first embodiment;

FIG. 3 is a processing flow of the hand movement correction controller 1 in the first embodiment;

FIG. 4 is a time chart of “normal correction mode” in the first embodiment;

FIG. 5 is a time chart of “mode of set back to center” in the first embodiment;

FIG. 6 is a time chart of “mode of correction only at exposure time” in the first embodiment;

FIG. 7 is a functional block diagram illustrating the hand movement correction controller 1 in the second embodiment;

FIG. 8 is a processing flow of the hand movement correction controller 1 in the second embodiment; and

FIG. 9 is a view illustrating a correspondence between the functional block diagram of the hand movement controller 1 in the first embodiment illustrated in FIG. 1 and a configuration in the present invention.

### BEST MODE FOR CARRYING OUT THE INVENTION

### First Embodiment

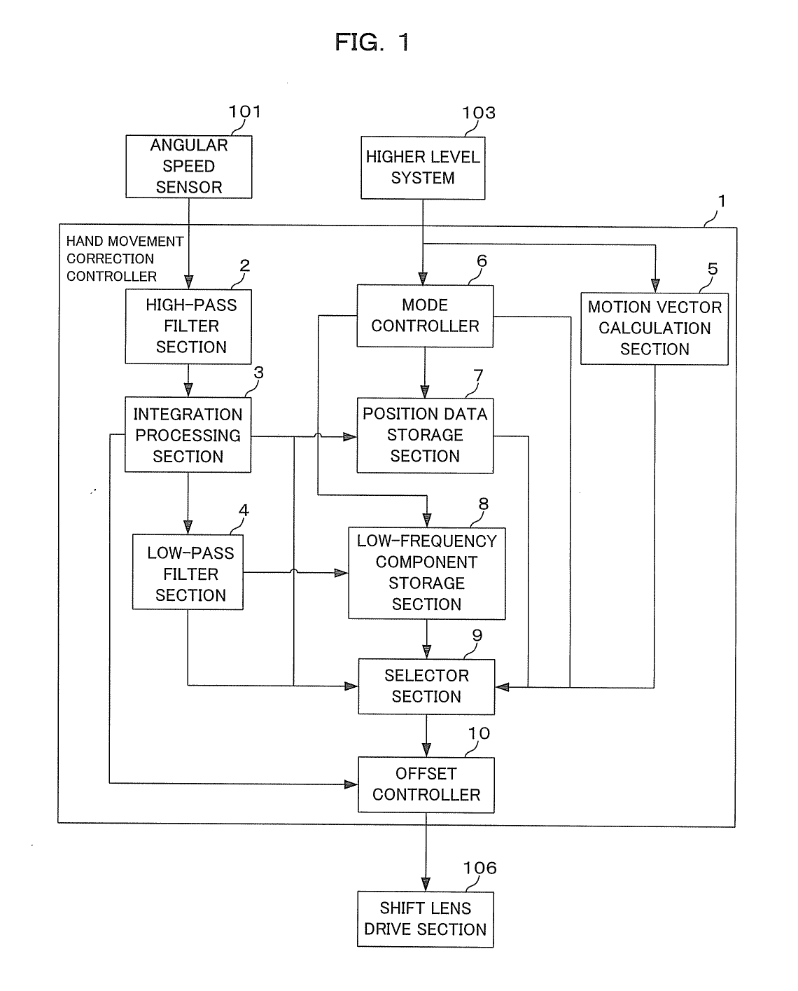

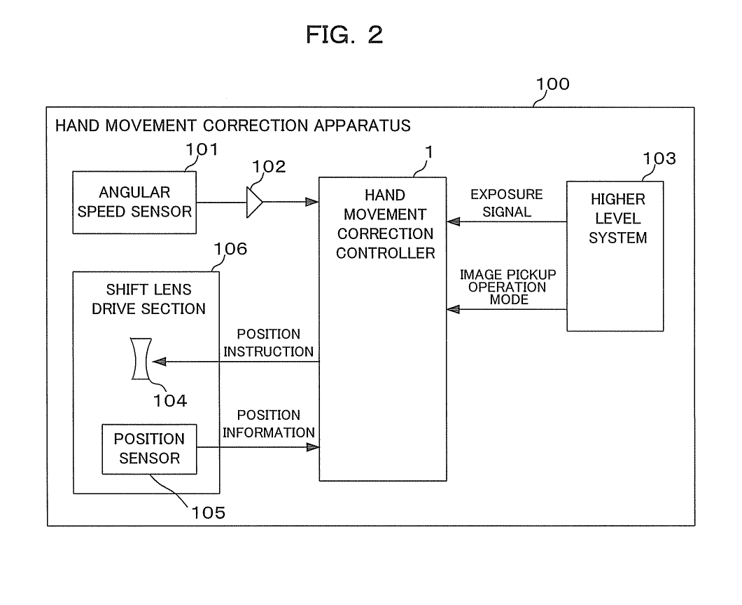

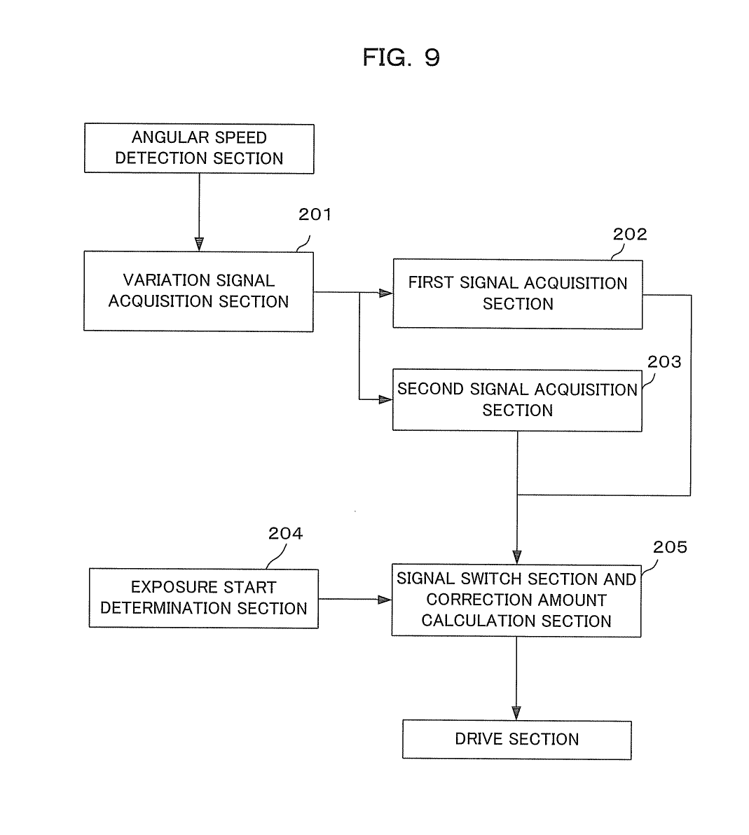

Embodiments of the present invention will be described below with reference to the accompanying drawings. In the following embodiments, a shift lens method which is a kind of optical hand movement correction method is adopted. FIG. 9 is a view schematically illustrating a configuration of a hand movement correction controller, FIG. 1 is a functional block diagram illustrating a hand movement correction controller 1, and FIG. 2 is a view illustrating configuration of a hand movement correction apparatus.

First, a configuration of a hand movement correction apparatus will be described with reference to FIG. 2. A hand movement correction apparatus 100 includes an angular speed sensor 101 for detecting a rotation angular speed and an angular speed sensor amplifier 102 for amplifying an angular speed signal output from the angular speed sensor 101. The hand movement correction apparatus 100 further includes a hand movement correction controller 1 for calculating a hand movement correction amount (DA) based on the angular speed signal output from the angular speed sensor 101. The hand movement correction apparatus 100 further includes a higher level system 103 that outputs, to the hand movement correction controller 1, an exposure signal which serves as a trigger for starting exposure and image pickup operation mode information which is information concerning an image pickup operation method.

The hand movement correction apparatus 100 further includes a shift lens drive section 106 and further includes, in the shift lens drive section 106, a shift lens 104 (optical system) that is driven in such a direction as to counteract a positional variation caused due to hand movement and a position sensor 105 for detecting the position of the shift lens 104.

Operation of the hand movement correction apparatus 100 in the present embodiment will be described. The angular speed sensor 101 detects a rotational angular speed, which is the movement caused due to hand movement, as an angular speed signal, and the angular speed sensor amplifier 102 amplifies the detected angular speed signal. The hand movement correction controller 1 calculates a hand movement correction amount (DA) based on the amplified angular speed signal and outputs the calculated hand movement correction amount (DA) to the shift lens drive section 106 (position instruction). The shift lens drive section 106 drives the shift lens 104 based on the input hand movement correction amount (DA), and the position sensor 105 detects the position of the shift lens 104 and transmits the detected position to the hand movement correction controller 1 as position information.

Further, the hand movement correction controller 1 changes the hand movement correction amount (DA) to be output to the shift lens drive section 106 based on the exposure signal and image pickup operation mode information output from the higher level system 103.

A schematic configuration of the hand movement correction controller 1 in the embodiment of the present invention will next be described with reference to FIG. 9. The hand movement correction controller 1 includes a variation signal acquisition section 201 that detects an angular speed to acquire a variation signal representing the movement of an image pickup apparatus, a first signal acquisition section 202 that acquires a first signal obtained by extracting, using a high-pass filter, a signal of a frequency not less than a predetermined frequency from the variation signal acquired by the variation signal acquisition section, a second signal acquisition section 203 that acquires a second signal obtained by extracting, using a low-pass filter, a signal of a frequency not more than a predetermined frequency from the variation signal acquired by the variation signal acquisition section and adding the extracted signal to the first signal, an exposure start determination section 204 that determines the start of exposure processing performed in the image pickup apparatus, a signal switch section that switches signal output from the first signal acquired by the first signal acquisition section to second signal acquired by the second signal acquisition section at the timing at which the start of the exposure processing is determined by the exposure start determination section, and a correction amount calculation section 205 that calculates a hand movement correction amount based on a signal output from the signal switch section.

A configuration of the hand movement correction controller 1 in the present embodiment will be described with reference to the functional block diagram of FIG. 1. The hand movement correction controller 1 includes a high-pass filter section 2 that applies high-pass filtering to the angular speed signal (which has been amplified by the angular speed sensor amplifier 102) from the angular speed sensor 101 to thereby remove a DC component from the angular speed sensor 101 and an integration processing section 3 that applies integration processing to the angular speed signal that has been subjected to the high-pass filtering by the high-pass filter section 2 to convert the angular speed signal into position data (Y0) (variation signal).

The hand movement correction controller 1 further includes a low-pass filter section 4 that extracts a low-frequency component having a frequency not more than a frequency which is developed based on a variation due to hand movement occurring at the time of image pickup from the position data (Y0) obtained by the integration processing section 3 to thereby output low-frequency component data (DC0). The hand movement correction controller 1 further includes a motion vector calculation section 5 that applies inversion calculation to the motion vector of an object to be image-picked up which is obtained through the image processing performed in the higher level system 103 using sign inversion to thereby output motion vector calculation data (V0). The hand movement correction controller 1 further includes a mode controller 6 that manages the image pickup operation mode information output from the higher level system 103 and a state of the exposure signal (in other words, the exposure processing) output from the higher level system 103.

The hand movement correction controller 1 further includes a position data storage section 7 that stores, at the timing at which the mode controller 6 receives the exposure signal, the position data (Y0) immediately before the exposure start as a fixed value referred to as stored position data (Y1) and a low-frequency component storage section 8 that stores, at the timing at which the mode controller 6 receives the exposure signal, the low-frequency component data (DC0) immediately before the exposure start as a fixed value referred to as stored low-frequency data (DC1).

The hand movement correction controller 1 further includes a selector section 9 that selects, as an offset value, one data from among the abovementioned data: position data (Y0), low-frequency component data (DC0), stored position data (Y1), stored low-frequency data (DC1), and motion vector calculation data (V0). The hand movement correction controller 1 further includes an offset controller 10 that subtracts the offset value selected by the selector section 9 from the position data (Y0).

Data calculated by the offset controller 10 is output, as the hand movement correction amount (DA), to the shift lens drive section 106, and the shift lens drive section 106 drives the shift lens 104 based on the hand movement correction amount (DA).

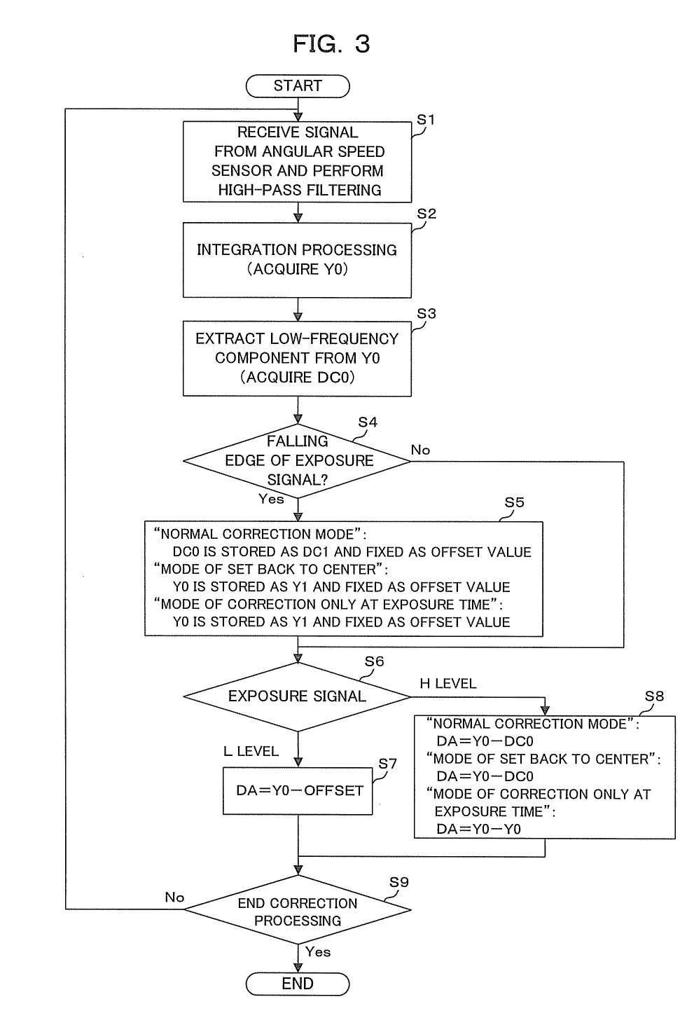

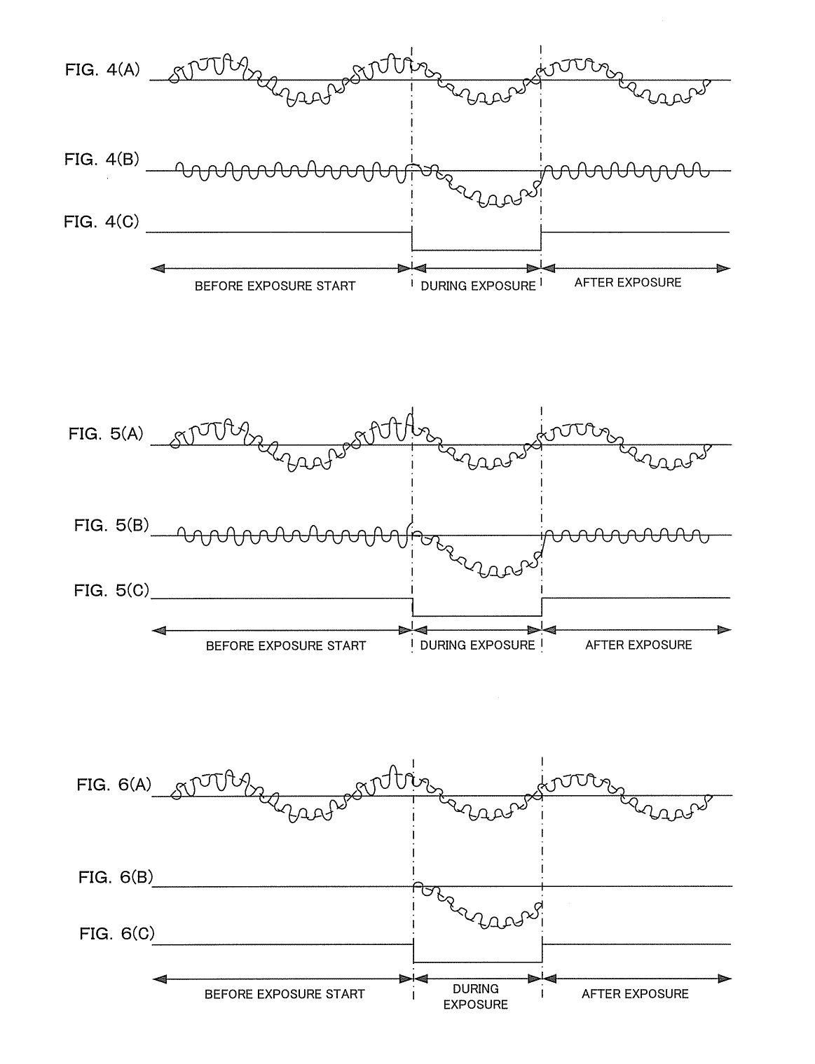

FIG. 3 illustrates a processing flow of the hand movement correction controller 1 in the present embodiment, and FIGS. 4 to 6 each illustrate a time chart of the hand movement correction controller 1. The time charts of FIGS. 4 to 6 are based on the image pickup operation mode information managed by the mode controller 6, and FIG. 4 illustrates “normal correction mode”, FIG. 5 illustrates “mode of set back to center”, and FIG. 6 illustrates “mode of correction only at exposure time”. Throughout the time charts of FIGS. 4 to 6, the horizontal axis represents time, vertical axis represents the hand movement correction amount (DA), a solid line represents a high-frequency component, and a broken line represents a low-frequency component. Further, throughout the time charts of FIGS. 4 to 6, (A) is a time chart in the case where hand movement correction processing is not performed, (B) is a time chart in the case where hand movement correction processing is performed based on each of the above modes, and (C) is a time chart of the exposure signal.

First, “normal correction mode” will be described. The angular speed signal (which has been amplified by the angular speed sensor amplifier 102) from the angular speed sensor 101 outputs a DC component, so that it does not become 0 even in a state (static state) where hand movement with respect to the hand movement correction apparatus 100 does not occur. In order to remove the DC component, the high-pass filter section 2 applies high-pass filtering (DC cut processing) to the angular speed signal (step S1).

The integration processing section 3 applies integration processing to the angular speed signal that has been subjected to the high-pass filtering to thereby convert the angular speed signal into the position data (Y0) (step S2). FIG. 4(A) illustrates a time chart illustrating a variation of only the position data (Y0) that has been subjected to the integration processing. The variation of only the position data (Y0) includes, in a mixed manner, a high-frequency component and low-frequency component.

Then, the low-pass filter section 4 extracts a low-frequency component from the position data (Y0) to thereby convert the position data (Y0) into low-frequency component data (DC0) (step S3).

Since processing of step 4 and subsequent steps in the processing flow differs depending on the state of the exposure signal managed by the mode controller 6, description will be made for each state of the exposure signal. The state of the exposure signal moves as follows: “before exposure start”→“moment of exposure start” (timing at which exposure start is determined)→“during exposure”→“after exposure”.

First, processing performed in the state “before exposure start” will be described. The mode controller 6 checks the state of the exposure signal output from the higher level system 103 and determined whether the current state of the exposure signal is “moment of exposure start” (falling edge of exposure signal) or not (step S4). Since the current state of the exposure signal is “before exposure start”, it is determined that the state of the exposure signal is not “moment of exposure start” (No in step S4), the processing is continued without change (to step S6). Then, the mode control section 6 determines whether the current state of the exposure signal is “during exposure” (hereinafter, referred to as “L level”, if necessary) or not (hereinafter, referred to as “H level”, if necessary) (step S6). Since the current state of the exposure signal is “before exposure start” (H level in step S6), the selector section 9 sets, as an offset value, the low-frequency component data (DC0). Then, the offset controller 10 calculates “hand movement correction amount (DA)=position data (Y0)−low-frequency component data (DC0)” (step S8). Based on the hand movement correction amount (DA) thus calculated, the shift lens drive section 106 drives the shift lens 104.

In the case where the hand movement correction processing of the hand movement correction controller 1 is successively performed (No in step S9), the flow returns to step S1 where the values of the position data (Y0) and low-frequency component data (DC0) are set newly. That is, the values of the position data (Y0) and low-frequency component data (DC0) are always varied.

In the case where the hand movement correction processing performed in the hand movement correction controller 1 is ended, (Yes in step S9), this processing flow is ended.

A time chart of the state “before exposure start” in “normal correction mode” is illustrated in “before exposure start” of FIG. 4(B). The hand movement correction amount (DA) in the state “before exposure start” is obtained by subtracting the low-frequency component data (DC0) from the variation of only the position data (Y0) illustrated in FIG. 4(A). Thus, the low-frequency component is cut off, with the result that the hand movement correction amount (DA) includes only a variation of a high-frequency component. Accordingly, correction control of the shift lens 104 is always performed near the center of a lens system, that is, the shift lens 104 is always subjected to centering with respect to the center of the correction range, so that the correction range can effectively utilized. Further, correction control is not made for a low-speed pan/tilt operation in which a user intentionally move an image pickup apparatus, and therefore complex logic can be eliminated.

However, when an image pickup operation is performed under the above condition, the correction amount on the lower-frequency side of a correction target frequency is significantly reduced. In order to cope with this, the characteristics of the hand movement correction are switched in the state “moment of exposure start”.

A case where the exposure signal is in the states “moment of exposure start” and “during exposure” in “normal correction mode” will be described. In the case where the current state of the exposure signal is “moment of exposure start”, the mode controller 6 receives the exposure signal from the higher level system 103 to thereby determine that the exposure signal is in the state “moment of exposure start” (falling edge of exposure signal) (Yes in step S4) and stores a value of the low-frequency component data (DC0) in the state “moment of exposure start” in the low-frequency component storage section 8 as the stored low-frequency data (DC1). At the same time, the selector section 9 sets (fixes) the stored low-frequency data (DC1) as an offset value (step S5). Further, since the current state of the exposure signal is “moment of exposure start”, the mode controller 6 determines that the exposure signal is in the state “during exposure” (L level) (L level in step S6), and the offset controller 10 stops the calculation of “hand movement correction amount (DA)=position data (Y0)−low-frequency component data (DC0)” and calculates “hand movement correction amount (DA)=position data (Y0)−stored low-frequency data (DC1)” (step S7).

Based on the hand movement correction amount (DA) thus calculated by the offset controller 10, the shift lens drive section 106 drives the shift lens 104.

In the case where the hand movement correction processing of the hand movement correction controller 1 is successively performed as the processing performed in the period from the start of the state “moment of exposure start” to the end of the state “during exposure” (No in step S9), the flow returns to step S1 where the values of the position data (Y0) and low-frequency component data (DC0) are set newly (step S2 and step S3).

After that, since the current state of the exposure signal is “during exposure”, the mode controller 6 determines that the exposure signal is not in the state “moment of exposure start” (falling edge of exposure signal) (No in step S4) but in the state “during exposure” (L level) (L level in step S6). According to the above determination result, the offset controller 10 subtracts, as an offset value (fixed value), the stored low-frequency data (DC1) set by the selector section 9 in the state “moment of exposure start” from the position data (Y0) that has been newly set to thereby calculate the hand movement correction amount (DA) (step S7).

As described above, the hand movement correction amount (DA) is calculated according to “hand movement correction amount (DA)=position data (Y0)−low-frequency component data (DC0)” until immediately before the exposure start; while, after the exposure start, the hand movement correction amount (DA) is calculated according to “hand movement correction amount (DA)=position data (Y0)—stored low-frequency data (DC1)”. At the time when the exposure signal is in the state “moment of exposure start”, “low-frequency component data (DC0)=stored low-frequency data (DC1)” is satisfied, so that no difference occurs between the values of the hand movement correction amount (DA) before and after the exposure start. Thus, a break does not occur in the continuity of the hand movement correction amount (DA) even at the moment of the exposure start, so that continuity of the hand movement correction amount can be kept.

The hand movement correction amount (DA) in the period from the start of the state “moment of exposure start” to the end of the state “during exposure” in “normal correction mode” is illustrated in the part “during exposure” of FIG. 4(B). The hand movement correction amount (DA) during this period can be calculated only by subtracting the fixed value (low-frequency component (DC1)) in the state “moment of exposure start” in place of the low-frequency component data (DC0) (variable value) from the position data (Y0), so that the frequency component of the position data (Y0) is not changed. As a result, also an ultra-low-frequency component caused by unintentional movement of a user of an image pickup device can be subjected to the correction.

In the case where the current state of the exposure signal in “normal correction mode” is “after exposure”, the exposure signal assumes H level again, so that the mode controller 6 determines that the exposure signal is not in the state “moment of exposure start” (falling edge of exposure signal) (No in step S4) and that the exposure signal assumes H level (H level in step S6). Thus, the same processing flow as the state “before exposure start” is performed, so that the description will be omitted. Further, the time chart of “after exposure” in “normal correction mode”, which is illustrated in the part “after exposure” of FIG. 4(B), is the same as the time chart of the part “before exposure start”, so that the description will be omitted.

With the above processing, it is possible to switch the characteristics of the hand movement correction at the moment of the exposure start while preventing a break in the continuity of the correction processing occurring before and after the exposure start and keeping the continuity of the correction calculation. Further, at the time when the exposure signal assumes H level, only a high-frequency component, which is obtained by cutting off the low-frequency component data from the original hand movement correction amount (DA), is subjected to the correction, so that the shift lens 104 can be retained near the center of the lens system. As a result, the correction range can be utilized to a maximum extent at the time when the exposure signal is in the state “during exposure”, thereby significantly improving the image pickup success rate.

Next, “mode of set back to center” will be described. This mode is a mode in which the shift lens 104 is forcibly driven (reset) to the center of the lens system at the moment of the exposure start. The processing flow and time chart in the state where the exposure signal assumes H level are the same as those in “normal correction mode”, so that the descriptions thereof will be omitted.

A case where the exposure signal is in the states “moment of exposure start” and “during exposure” in “mode of set back to center” will be described. In the case where the current state of the exposure signal is “moment of exposure start”, the mode controller 6 receives the exposure signal from the higher level system 103 to thereby determine that the exposure signal is in the state “moment of exposure start” (falling edge of exposure signal) (Yes in step S4) and stores a value of the position data (Y0) in the state “moment of exposure start” in the position data storage section 7 as the fixed value (stored position data (Y1)). At the same time, the selector section 9 sets (fixes) the stored position data (Y1) as an offset value (step S5).

Further, since the current state of the exposure signal is “moment of exposure start”, the mode controller 6 determines that the exposure signal is in the state “during exposure” (L level) (L level in step S6), and the offset controller 10 stops the calculation of “hand movement correction amount (DA)=position data (Y0)−low-frequency component data (DC0)” which has been performed in the state “before exposure start” and calculates “hand movement correction amount (DA)=position data (Y0)−stored position data (Y1)” (step S7).

Based on the hand movement correction amount (DA) calculated as described above, the shift lens drive section 106 drives the shift lens 104.

In the case where the hand movement correction processing of the hand movement correction controller 1 is successively performed as the processing performed in the period from the start of the state “moment of exposure start” to the end of the state “during exposure” (No in step S9), the flow returns to step S1 where the values of the position data (Y0) and low-frequency component data (DC0) are set newly (step S2 and step S3). That is, the values of the position data (Y0) and low-frequency component data (DC0) are always varied.

After that, since the current state of the exposure signal is “during exposure”, the mode controller 6 determines that the exposure signal is not in the state “moment of exposure start” (falling edge of exposure signal) (No in step S4) but in the state “during exposure” (L level) (L level in step S6). According to the above determination result, the offset controller 10 subtracts, as an offset value (fixed value), the stored position data (Y1) set by the selector section 9 in the state “moment of exposure start” from the position data (Y0) that has been newly set to thereby calculate the hand movement correction amount (DA) (step S7).

In the case where the current state of the exposure signal is “moment of exposure start”, “position data (Y0)=stored position data (Y1)” is satisfied, and the value of the hand movement correction amount (DA) (=position data (Y0)−stored position data (Y1)) is 0, so that the shift lens 104 is forcibly driven (reset) to the center of the lens system, and a reset value is output as an initial value of the hand movement correction amount (DA) in the state “during exposure”.

A time chart of the period from the start of the state “moment of exposure start” to the end of the “during exposure” in “mode of set back to center” is illustrated in the part “during exposure” of FIG. 5(B). The hand movement correction amount (DA) in the state “during exposure” can be calculated only by subtracting the fixed value (stored position data (Y1)) in the state “moment of exposure start” in place of the variable value (low-frequency component data (DC0)) from the position data (Y0), so that the frequency component of the position data (Y0) is not changed. As a result, as in the case of “normal correction mode”, also an ultra-low-frequency component caused by unintentional movement of a user of an image pickup apparatus can be subjected to the correction.

With the above processing, it is possible to instantly switch the characteristics of the correction, as well as, to forcibly drive the shift lens 104 to the center of the lens system immediately before the exposure start. As a result, the maximum value of the correction range can effectively be utilized at the time when the exposure signal is in the state “during exposure”, thereby significantly improving the image pickup success rate. Further, after the shift lens 104 is forcibly driven to the center of the lens system (At the time when the exposure signal is in the state “during exposure”), the hand movement correction amount (DA) can be calculated only by subtracting the fixed value (stored position data (Y1)) from the position data (Y0), so that the subsequent correction amount can instantly be calculated without error, and the continuity of the hand movement correction amount can be kept in the state “during exposure”.

Next, “mode of correction only at exposure time” will be described. This mode is a mode in which the shift lens 104 is made stationary at the center of the lens system in a state where the exposure signal assumes H level (in the state “before exposure start” or “after exposure”) so as to enable the hand movement correction only during exposure time.

Processing performed in the state “before exposure start” in “mode of correction only at exposure time” will be described with reference to the flowchart of FIG. 3. The processing from step S1 to step S3 is the same as that in “normal correction mode”, so that the description thereof will be omitted.

Since the current state of the exposure signal is “before exposure start”, the mode controller 6 determines that the exposure signal is not in the “moment of exposure start” (falling edge of exposure signal) (No in step S4) and that the exposure signal assumes H level (H level in step S6).

The selector section 9 sets, as an offset value, the position data (Y0). Then, the offset controller 10 calculates “hand movement correction amount (DA)=position data (Y0)−position data (Y0)” (step S8). The hand movement correction amount (DA) thus calculated becomes 0. As long as the hand movement correction processing of the hand movement correction controller 1 continues (No in step S9) and as long as the mode controller 6 determines that the exposure signal is not in the state “moment of exposure start” (falling edge of exposure signal) (No in step S4) and that the exposure signal assumes H level (H level in step S6), the value of the hand movement correction amount becomes 0 and, accordingly, the shift lens 104 is made stationary at the center of the lens system.

The processing flows in the state “moment of exposure start” (Yes in step S4) and in the state “during exposure” (L level in step S6) in “mode of correction only at exposure time” are the same as those in “mode of set back to center”, so that the descriptions thereof will be omitted. Further, the processing flow at the time when the current state of the exposure signal is “after exposure” in “mode of correction only at exposure time” is the same as in the case of the state “before exposure start” in “mode of correction only at exposure time”, and the description thereof will be omitted.

A time chart in “mode of correction only at exposure time” is illustrated in FIG. 6(B). In the case where the exposure signal assumes H level (in the states “before exposure start” and “after exposure” of FIG. 6(B)), the hand movement correction amount (DA) is kept fixed at 0, and only in the case where the exposure signal is in the state “during exposure”, the hand movement correction amount (DA) appears with a low-frequency component and high-frequency component. Further, in the state “during exposure”, the hand movement correction amount (DA) can be calculated only by subtracting the fixed value (stored position data (Y1)) in the state “moment of exposure start” from the position data (Y0), so that the frequency component of the position data (Y0) is not changed. As a result, as in the case of “normal correction mode”, also an ultra-low-frequency component caused by unintentional movement of a user of an image pickup apparatus can be subjected to the correction.

With the above processing, it is possible to achieve a configuration in which the correction control can be performed only during the exposure. Further, the correction amount can instantly be calculated without error with the continuity thereof kept. Further, the shift lens 104 can be made stationary at the center of the lens system until immediately before the moment of the exposure start, so that the maximum value of the correction range can effectively be utilized, thereby significantly improving the image pickup success rate. Further, the shift lens 104 is not moved except during the exposure (i.e., at the time when the exposure signal assumes H level), so that power consumed for driving the shift lens 104 can be reduced.

Next, as an application example of the above modes, “panning mode” in which image pickup operation is performed with an image pickup panned to follow an moving object will be described. In the case where image pickup operation is performed with an image pickup panned to follow a moving object, image blur is more noticeable than in the case where image pickup operation is performed for an object at rest. However, with the “panning mode”, satisfactory image pickup can be performed.

In the case where the mode controller 6 determines that the current state of the exposure signal is “moment of exposure start”, the selector section 9 sets, as an offset value, the motion vector calculation data (V0) output from the motion vector calculation section 5, and the offset controller 10 adds the motion vector calculation data (V0) to the position data (Y0) that includes a component for intentionally activating the hand movement correction apparatus 100 to thereby output the hand movement correction amount (DA). With the above processing, the shift lens 104 can be driven with the hand movement correction being performed, with result that panning can automatically be performed. The processing performed in the state where the exposure signal assumes H level (states “before exposure start” and “after exposure”) in “panning mode” is the same as in the case of “normal operation mode”, so that the description thereof will be omitted.

### Second Embodiment

The hand movement correction controller in the present embodiment calculates a tilt caused due to hand movement by applying a differential or the like to the low-frequency component data (DC0) in the state “moment of exposure start” in both “mode of set back to center” and “mode of correction only at exposure time” in the abovementioned first embodiment. By estimating near future movement based on the calculated direction and magnitude of the tilt and by setting an offset from the center of the shift lens in accordance with the tilt amount, a more wide control range for correction can be obtained.

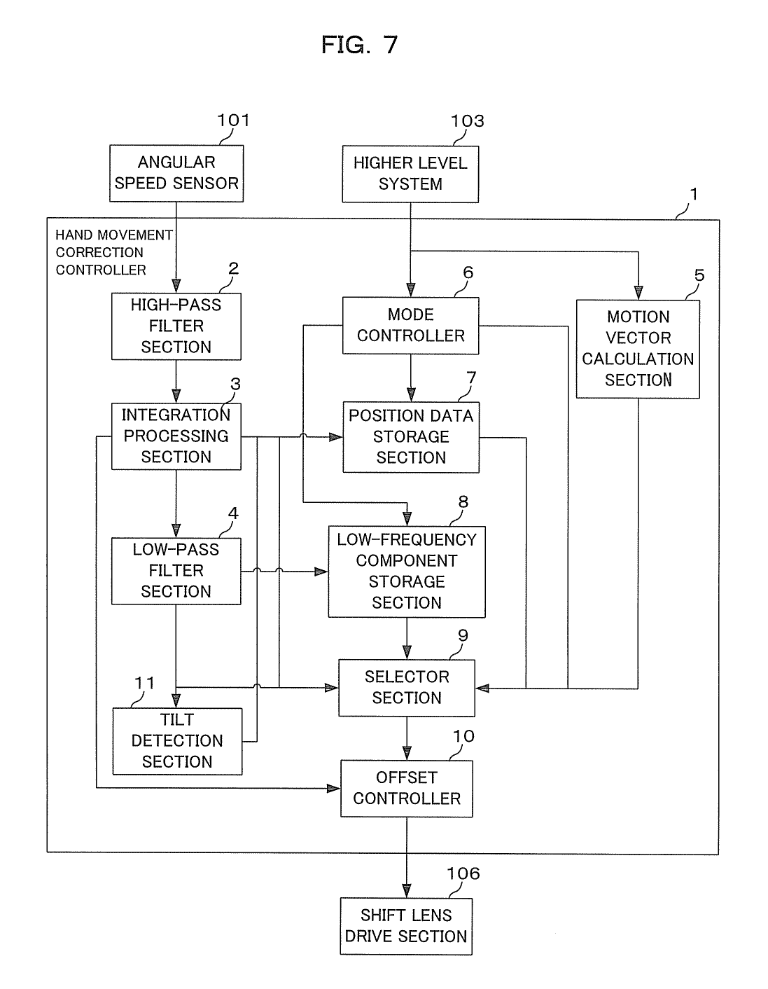

FIG. 7 is a functional block diagram of the hand movement correction controller in the present embodiment. A tilt detection section 11 that calculates a tilt component (ΔDC0×K) based on the low-frequency component data (DC0) extracted by the low-pass filter section 4 is additionally provided in the hand movement correction controller 1 of the first embodiment. The configuration except for this point is the same as that of the first embodiment, and the description thereof will be omitted.

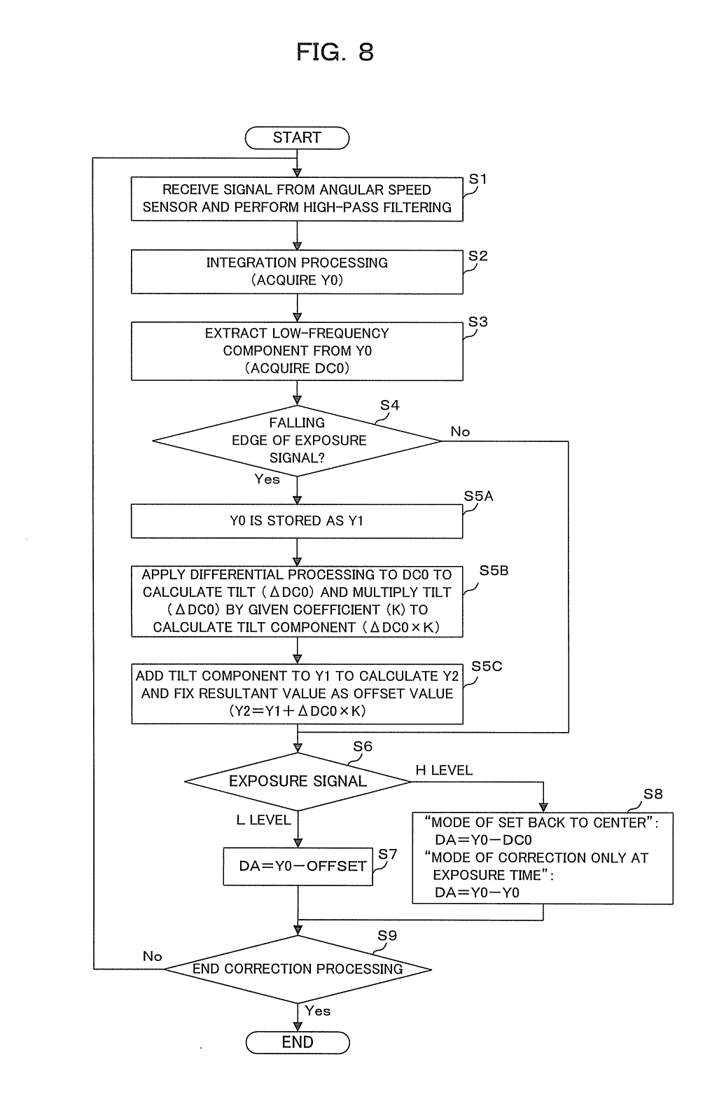

Processing performed in the present embodiment will be described with reference to a flowchart of FIG. 8. The processing performed at the time when the exposure signal is in the states “before exposure start” and “after exposure” (No in step S4 and H level in step S6 of FIG. 8) is the same as that performed at the time when the exposure signal is in the states “before exposure start” and “after exposure” in both “mode of set back to center” and “mode of correction only at exposure time”, so that the description thereof will be omitted.

In the case where the current state of the exposure signal is “moment of exposure start”, the mode controller 6 receives the exposure signal from the higher level system 103 to thereby determine that the exposure signal is in the “moment of exposure start” (falling edge of exposure signal) (Yes in step S4). After that, the mode controller 6 stores a value of the position data (Y0) in the state “moment of exposure start” in the position data storage section 7 as the fixed value (stored position data (Y1)) (step S5A). The processing from step S1 to step S3 is the same as that in the first embodiment, so that the description thereof will be omitted.

The tilt detection section 11 applies differential processing to the low-frequency component data (DC0) to calculate a tilt (ΔDC0) caused due to hand movement and multiplies the tilt (ΔDC0) by a certain coefficient (K) to calculate a tilt component (ΔDC0×K) (step S5B).

Then, the tilt detection section 11 adds the calculated tilt component (ΔDC0×K) to the stored position data (Y1) and stores the resultant value in the position data storage section 7 as stored tilt component data (Y2). Thus, the value (stored tilt component data (Y2)) stored in the position data storage section 7 is represented as “Y2=Y1+ΔDC0×K” (step S5C).

The selector section 9 sets (fixes), as an offset value, the stored tilt component data (Y2) (step S5C).

Since the current state of the exposure signal is “moment of exposure start”, the mode controller 6 determines that the exposure signal has entered the state “during exposure” (L level) (L level of step S6). Then, the offset controller 10 stops the processing performed in the state “before exposure start” (“hand movement correction amount (DA)=position data (Y0)−low-frequency component data (DC0)” in the case of “mode of set back to center”, and “hand movement correction amount (DA)=position data (Y0)−position data (Y0)” in the case of “mode of correction only at exposure time”) and calculates “hand movement correction amount (DA)=position data (Y0)−stored position data (Y2)” (step S7).

Based on the hand movement correction amount (DA) thus calculated, the shift lens drive section 106 drives the shift lens 104.

In the case where the hand movement correction processing of the hand movement correction controller 1 is successively performed as the processing performed in the period from the start of the state “moment of exposure start” to the end of the state “during exposure” (No in step S9), the flow returns to step S1 where the values of the position data (Y0) and low-frequency component data (DC0) are set newly (step S2 and step S3). That is, the values of the position data (Y0) and low-frequency component data (DC0) are always varied.

After that, since the current state of the exposure signal is “during exposure”, the mode controller 6 determines that the exposure signal is not in the state “moment of exposure start” (falling edge of exposure signal) (No in step S4) but in the state “during exposure” (L level) (L level in step S6). According to the above determination result, the offset controller 10 subtracts, as an offset value (fixed value), the stored tilt component data (Y2) set in the state “moment of exposure start” from the position data (Y0) that has been newly set to thereby calculate the hand movement correction amount (DA) (step S7). In the case where the current state of the exposure signal is “during exposure”, the above processing (loop from No in step S9 to step S1) is repeated.

According to the present embodiment, the hand movement correction apparatus 100 forcibly moves the shift lens to a best position near the center in the state “moment of exposure start”, thereby utilizing the maximum value of the correction range at the exposure time, which allows the control range for correction in the state “during exposure” to be ensured. Further, in the state “during exposure”, the hand movement correction apparatus 100 can apply correction to a wide area from ultra-low-frequency to high-frequency and can perform correction control with the continuity of the correction calculation kept.

Although the correction is achieved by driving the shift lens 104 in the above first and second embodiments, the configurations of the first and second embodiments can be applied to various types of image pickup apparatus having a hand movement correction function. For example, the configurations of the first and second embodiments can serve as an effective means in a system that performs the hand movement correction by deriving an image pickup device such as a CCD.

Further, the hand movement correction apparatus according to the first and second embodiments can be applied to various types of image pickup apparatus represented by a digital still camera. Further, the first and second embodiments can be used as a hand movement correction method or an image pickup method, as well as, as a correction program or an image pickup program executed by a computer.

“Mode of correction only at exposure time” in the first embodiment is achieved by using a hand movement correction apparatus that performs hand movement correction for an image pickup apparatus, including: a variation signal acquisition section that acquires a variation signal representing the movement of the image pickup apparatus; a signal acquisition section that acquires a signal obtained by extracting a signal of a frequency for hand movement correction which is used in the hand movement correction from the variation signal acquired by the variation signal acquisition section; an exposure start determination section that determines the start of exposure processing performed in the image pickup apparatus; and a correction amount calculation section that calculates, at the timing at which the start of the exposure processing is determined by the exposure start determination section, a hand movement correction amount using the signal output acquired by the signal acquisition section.

“Mode of correction only at exposure time” in the first embodiment is achieved by using a hand movement correction program allowing a computer to execute hand movement correction for an image pickup apparatus, the program allowing the computer to execute: a variation signal acquisition step that acquires a variation signal representing the movement of the image pickup apparatus; a signal acquisition step that acquires a signal obtained by extracting a signal of a frequency for hand movement correction which is used in the hand movement correction from the variation signal acquired by the variation signal acquisition step; an exposure start determination step that determines the start of exposure processing performed in the image pickup apparatus; and a correction amount calculation step that calculates, at the timing at which the start of the exposure processing is determined by the exposure start determination step, a hand movement correction amount using the signal output acquired by the signal acquisition step.

“Mode of correction only at exposure time” in the first embodiment is achieved by using a hand movement correction method that performs hand movement correction for an image pickup apparatus, including: a variation signal acquisition step that acquires a variation signal representing the movement of the image pickup apparatus; a signal acquisition step that acquires a signal obtained by extracting a signal of a frequency for hand movement correction which is used in the hand movement correction from the variation signal acquired by the variation signal acquisition step; an exposure start determination step that determines the start of exposure processing performed in the image pickup apparatus; and a correction amount calculation step that calculates, at the timing at which the start of the exposure processing is determined by the exposure start determination step, a hand movement correction amount using the signal output acquired by the signal acquisition step.

### INDUSTRIAL APPLICABILITY

As described above, according to the present invention, it is possible to significantly increase the image pickup success rate by exploiting the hand movement correction effect.

1. A hand movement correction apparatus that performs hand movement correction for an image pickup apparatus, comprising:
a variation signal acquisition section that acquires a variation signal representing the movement of the image pickup apparatus;
a first signal acquisition section that acquires a first signal obtained by extracting a signal of a frequency not less than a predetermined frequency from the variation signal acquired by the variation signal acquisition section;
a second signal acquisition section that acquires a second signal obtained by extracting a signal of a frequency not more than a predetermined frequency from the variation signal acquired by the variation signal acquisition section and adding the extracted signal to the first signal;
an exposure start determination section that determines the start of exposure processing performed in the image pickup apparatus;
a signal switch section that switches signal output from the first signal acquired by the first signal acquisition section to second signal acquired by the second signal acquisition section at the timing at which the start of the exposure processing is determined by the exposure start determination section; and
a correction amount calculation section that calculates a hand movement correction amount based on the signal output from the signal switch section.

2. The hand movement correction apparatus according to claim 1, wherein
the correction amount calculation section calculates, at the timing, the hand movement correction amount based on the second signal using the hand movement correction amount that has been calculated based on the first signal as an initial value.

3. The hand movement correction apparatus according to claim 1, wherein
the correction amount calculation section calculates, at the timing, the hand movement correction amount based on the second signal with the hand movement correction amount that has been calculated based on the first signal reset.

4. The hand movement correction apparatus according to claim 1, comprising a drive section that drives an optical system based on the hand movement correction amount calculated by the correction amount calculation section.

5. The hand movement correction apparatus according to claim 1, comprising a drive section that drives an image pickup device based on the hand movement correction amount calculated by the correction amount calculation section.

6. A hand movement correction apparatus that performs hand movement correction for an image pickup apparatus, comprising:
an angular speed detection section that detects a rotation angular speed representing the movement of the image pickup apparatus;
a high-pass filter section that outputs a DC-cut data obtained by removing a DC component from the angular speed detected by the angular speed detection section;
an integration processing section that outputs, as position data, the position of the image pickup apparatus based on the DC-cut data output from the high-pass filter section;
a low-pass filter section that extracts, for output, low-frequency component data of a frequency not more than a frequency developed based on a variation caused due to hand movement caused at the time of image pickup from the position data output from the integration processing section;
a motion vector calculation section that applies inversion calculation to the motion vector of an object to be image-picked up which is picked up by the image pickup apparatus using sign inversion to output motion vector calculation data;
a mode controller that determines the state of exposure processing performed in the image pickup apparatus and manages image pickup operation mode information which is information concerning an image pickup method;
a position data storage section that stores, at the timing of the start of the exposure processing determined by the mode controller, the position data output from the integration processing section as stored position data;
a low-frequency component storage section that stores, at the timing of the start of the exposure processing determined by the mode controller, the low-frequency component data output from the low-pass filter section as stored low-frequency data;
a selector section that selects, as an offset value, one of the position data, low-frequency component data, stored position data, stored low-frequency data, and motion vector calculation data based on the image pickup operation mode information managed by the mode controller and the state of the exposure processing determined by the mode controller; and
an offset controller that performs calculation for the position data output from the integration processing section using the offset value selected by the selector section to output the correction amount of the hand movement correction.

7. An image pickup apparatus that can perform hand movement correction, comprising:
an image pickup device;
an optical system that guides light to the image pickup device;
a variation signal acquisition section that acquires a variation signal representing the movement of the image pickup apparatus;
a first signal acquisition section that acquires a first signal obtained by extracting a signal of a frequency not more than a first frequency from the variation signal acquired by the variation signal acquisition section;
a second signal acquisition section that acquires a second signal obtained by extracting a signal of a frequency not more than a second frequency less than the first frequency from the variation signal acquired by the variation signal acquisition section;
an exposure start determination section that determines the start of exposure processing performed in the image pickup apparatus;
a signal switch section that switches signal output from the first signal acquired by the first signal acquisition section to second signal acquired by the second signal acquisition section at the timing at which the start of the exposure processing is determined by the exposure start determination section;
a correction amount calculation section that calculates a hand movement correction amount based on the signal output from the signal switch section; and
a drive section that drives at least one of the optical system and image pickup device based on the hand movement correction amount calculated by the correction amount calculation section.

8. A hand movement correction program allowing a computer to execute hand movement correction for an image pickup apparatus; the program allowing the computer to execute:
a variation signal acquisition step that acquires a variation signal representing the movement of the image pickup apparatus;
a first signal acquisition step that acquires a first signal obtained by extracting a signal of a frequency not less than a predetermined frequency from the variation signal acquired by the variation signal acquisition step;
a second signal acquisition step that acquires a second signal obtained by extracting a signal of a frequency not more than a predetermined frequency from the variation signal acquired by the variation signal acquisition step and adding the extracted signal to the first signal;
an exposure start determination step that determines the start of exposure processing performed in the image pickup apparatus;
a signal switch step that switches signal output from the first signal acquired by the first signal acquisition step to second signal acquired by the second signal acquisition step at the timing at which the start of the exposure processing is determined by the exposure start determination step; and
a correction amount calculation step that calculates a hand movement correction amount based on the signal output from the signal switch step.

9. The hand movement correction program according to claim 8, wherein
the correction amount calculation step calculates, at the determination timing, the hand movement correction amount based on the second signal using the hand movement correction amount that has been calculated based on the first signal as an initial value.

10. The hand movement correction program according to claim 8, wherein
the correction amount calculation step calculates, at the determination timing, the hand movement correction amount based on the second signal with the hand movement correction amount that has been calculated based on the first signal reset.

11. The hand movement correction program according to any of claims 8 to 10, allowing the computer to execute a drive step that drives an optical system based on the hand movement correction amount calculated by the correction amount calculation step.

12. The hand movement correction program according to any of claims 8 to 10, allowing the computer to execute a drive step that drives an image pickup device based on the hand movement correction amount calculated by the correction amount calculation step.

13. A hand movement correction program allowing a computer to execute hand movement correction for an image pickup apparatus; the program allowing the computer to execute:
an angular speed acquisition step that acquires a rotation angular speed data representing the movement of the image pickup apparatus;
a high-pass filter step that outputs a DC-cut data obtained by removing a DC component from the angular speed data acquired by the angular speed acquisition step;
an integration processing step that outputs, as position data, the position of the image pickup apparatus based on the DC-cut data output from the high-pass filter step;
a low-pass filter step that extracts, for output, low-frequency component data of a frequency not more than a frequency developed based on a variation caused due to hand movement caused at the time of image pickup from the position data output from the integration processing step;
a motion vector calculation step that applies inversion calculation to the motion vector of an object to be image-picked up which is picked up by the image pickup apparatus using sign inversion to output motion vector calculation data;
a mode control step that determines the state of exposure processing performed in the image pickup apparatus and manages image pickup operation mode information which is information concerning an image pickup method;
a position data storage step that stores, at the timing of the start of the exposure processing determined by the mode control step, the position data output from the integration processing step as stored position data;
a low-frequency component storage step that stores, at the timing of the start of the exposure processing determined by the low-pass filter step as stored position data;
a selector step that selects, as an offset value, one of the position data, low-frequency component data, stored position data, stored low-frequency data, and motion vector calculation data based on the image pickup operation mode information managed by the mode control step and the state of the exposure processing determined by the mode control step; and
an offset control step that performs calculation for the position data output from the integration processing step using the offset value selected by the selector step to output the correction amount of the hand movement correction.

14. An image pickup program of an image pickup apparatus that includes an image pickup device and an optical system that guides light to the image pickup device and that can perform hand movement correction, the program allowing a computer to execute:
a variation signal acquisition step that acquires a variation signal representing the movement of the image pickup apparatus;
a first signal acquisition step that acquires a first signal obtained by extracting a signal of a frequency not more than a first frequency from the variation signal acquired by the variation signal acquisition step;
a second signal acquisition step that acquires a second signal obtained by extracting a signal of a frequency not more than a second frequency less than the first frequency from the variation signal acquired by the variation signal acquisition step;
an exposure start determination step that determines the start of exposure processing performed in the image pickup apparatus;
a signal switch step that switches signal output from the first signal acquired by the first signal acquisition step to second signal acquired by the second signal acquisition step at the timing at which the start of the exposure processing is determined by the exposure start determination step;
a correction amount calculation step that calculates a hand movement correction amount based on the signal output from the signal switch step; and
a drive step that drives at least one of the optical system and image pickup device based on the hand movement correction amount calculated by the correction amount calculation step.

15. A hand movement correction method that performs hand movement correction for an image pickup apparatus, comprising:
a variation signal acquisition step that acquires a variation signal representing the movement of the image pickup apparatus;
a first signal acquisition step that acquires a first signal obtained by extracting a signal of a frequency not less than a predetermined frequency from the variation signal acquired by the variation signal acquisition step;
a second signal acquisition step that acquires a second signal obtained by extracting a signal of a frequency not more than a predetermined frequency from the variation signal acquired by the variation signal acquisition step and adding the extracted signal to the first signal;
an exposure start determination step that determines the start of exposure processing performed in the image pickup apparatus;
a signal switch step that switches signal output from the first signal acquired by the first signal acquisition step to second signal acquired by the second signal acquisition step at the timing at which the start of the exposure processing is determined by the exposure start determination step; and
a correction amount calculation step that calculates a hand movement correction amount based on the signal output from the signal switch step.

16. The hand movement correction method according to claim 15, wherein
the correction amount calculation step calculates, at the timing, the hand movement correction amount based on the second signal using the hand movement correction amount that has been calculated based on the first signal as an initial value.

17. The hand movement correction method according to claim 15, wherein
the correction amount calculation step calculates, at the timing, the hand movement correction amount based on the second signal with the hand movement correction amount that has been calculated based on the first signal reset.

18. The hand movement correction method according to any of claims 15 to 17, comprising a drive step that drives an optical system based on the hand movement correction amount calculated by the correction amount calculation step.

19. The hand movement correction method according to any of claims 15 to 17, comprising a drive step that drives an image pickup device based on the hand movement correction amount calculated by the correction amount calculation step.

20. A hand movement correction method that performs hand movement correction for an image pickup apparatus, comprising:
an angular speed acquisition step that acquires a rotation angular speed data representing the movement of the image pickup apparatus;
a high-pass filter step that outputs a DC-cut data obtained by removing a DC component from the angular speed data acquired by the angular speed acquisition step;
an integration processing step that outputs, as position data, the position of the image pickup apparatus based on the DC-cut data output from the high-pass filter step;
a low-pass filter step that extracts, for output, low-frequency component data of a frequency not more than a frequency developed based on a variation caused due to hand movement caused at the time of image pickup from the position data output from the integration processing step;
a motion vector calculation step that applies inversion calculation to the motion vector of an object to be image-picked up which is picked up by the image pickup apparatus using sign inversion to output motion vector calculation data;
a mode control step that determines the state of exposure processing performed in the image pickup apparatus and manages image pickup operation mode information which is information concerning an image pickup method;
a position data storage step that stores, at the timing of the start of the exposure processing determined by the mode control step, the position data output from the integration processing step as stored position data;
a low-frequency component storage step that stores, at the timing of the start of the exposure processing determined by the mode control step, the low-frequency component data output from the low-pass filter step as stored low-frequency data;
a selector step that selects, as an offset value, one of the position data, low-frequency component data, stored position data, stored low-frequency data, and motion vector calculation data based on the image pickup operation mode information managed by the mode control step and the state of the exposure processing determined by the mode control step; and
an offset control step that performs calculation for the position data output from the integration processing step using the offset value selected by the selector step to output the correction amount of the hand movement correction.

21. An image pickup method of an image pickup apparatus that includes an image pickup device and an optical system that guides light to the image pickup device and that can perform hand movement correction, the method comprising:
a variation signal acquisition step that acquires a variation signal representing the movement of the image pickup apparatus;
a first signal acquisition step that acquires a first signal obtained by extracting a signal of a frequency not more than a first frequency from the variation signal acquired by the variation signal acquisition step;
a second signal acquisition step that acquires a second signal obtained by extracting a signal of a frequency not more than a second frequency less than the first frequency from the variation signal acquired by the variation signal acquisition step;
an exposure start determination step that determines the start of exposure processing performed in the image pickup apparatus;
a signal switch step that switches signal output from the first signal acquired by the first signal acquisition step to second signal acquired by the second signal acquisition step at the timing at which the start of the exposure processing is determined by the exposure start determination step;
a correction amount calculation step that calculates a hand movement correction amount based on the signal output from the signal switch step; and
a drive step that drives at least one of the optical system and image pickup device based on the hand movement correction amount calculated by the correction amount calculation step.
